(19) United States
(12) Patent Application Publication
(10) Pub. No.: US 2003/0018753 A1
(43) Pub. Date: Jan. 23, 2003

(54) Remote control proxy method and apparatus

(76) Inventor: Ryuken Seki, Sagamihara-shi (JP)

Correspondence Address: STEVENS, DAVIS, MILLER & MOSHER, L.L.P., Suite 850, 1615 L Street, N.W., Washington, DC, 20036, US

(21) Appl. No.: 10/195,406

(22) Filed: Jul. 16, 2002

(30) Foreign Application Priority Data
Jul. 18, 2001 (JP) 2001-218604

(51) Int. Cl. G06F 15/16

(52) U.S. Cl. 709/219

(57) ABSTRACT

A gateway assigns an identifier to a home-network apparatus and associates the identifier with URL of a proxy server to register. A home page containing the identifier of the home-network apparatus and URL of the proxy server is generated, and the content data is transmitted to the remote terminal. The remote terminal makes a connection request on the home page to the proxy server of the home-network apparatus and acquires a home page for control. When the remote terminal transmits a control request message in the HTTP protocol, the proxy server converts the message into a command to transmit to the gateway. The gateway performs address conversion and protocol conversion on the control command to transfer to the home-network apparatus.

### BACKGROUND OF THE INVENTION

1. Field of the Invention

The present invention relates to a remote control proxy method and apparatus for remotely controlling controlled apparatuses on a home network from an external network.

2. Description of the Related Art

Conventionally, electrical apparatuses exiting in the home rarely have the network computing function like a computer. However, in recent years, standardizing techniques have been performed widely to connect the home apparatuses, particularly non-PC apparatuses (specifically, electrical appliances such as AV devices such as a digital TV, VTR and monitoring camera, refrigerator and microwave oven which are not general computer unlike a personal computer, but are special-purpose apparatuses have the dedicate function corresponding to their respective use) on a home network to control each apparatus or transfer data between the apparatuses.

Network specifications for non-PC apparatuses are first studied and standardized. For example, leading standards are IEEE 1394 and HAVi (Home Audio/Video interoperability) that is the middleware on IEEE 1394 network for AV network for use in digital TV, VTR, etc. and ECHONET for home appliances. Other examples are Jini that is the middleware on a Java (trademark), which is Object-Oriented language, basis, and UPnP (Universal Plug and Play) that is the middleware on an Internet protocol basis.

According to these specifications, it is possible to control devices and apparatuses accommodated in respective networks. Further, mutual connection and control between the network specifications, i.e., different networks such as HAVi and Jini have been advanced. However, such studies are focused on mutual connection between different networks in the home.

Meanwhile, some studies have been performed on a method of controlling devices and apparatuses on a home network froman external network typified by the internet. These studies are primarily divided to two from the viewpoint of forms for transmitting control commands on the external network. In addition, in the following description, a gateway means an apparatus which is disposed in the home or office and which connects an internal network in the home or SOHO/ROBO (Small Office/Home Office and Remote Office/Branch Office) to an external network connected to a service provider.

(1) A gateway opens types of services, which home apparatuses provide, to the public and converts a control command received from an external-network terminal into a control command that can be directly interpreted by the home apparatus, whereby control and services of the home apparatuses are achieved; and

(2) An external-network terminal transmits a control command that can be directly interpreted by a home apparatus via a gateway transparently by end-by-end, whereby control and services of the home apparatuses are achieved.

An example of item (1) is OSGi (Open Service Gateway initiative). OSGi aims standardization on API (Application Programming Interface) of gateway. Among core API relating to remote service management, apparatus management and resource management, optional API defines a mechanism of mutual communications between a gateway and client, and data management.

An example of recent studies on item (1) is a technique disclosed in Japanese Laid-Open Patent Publication HEI11-187061. The technique relates to a method in which a gateway maps services that home apparatuses provide on URL (Uniform Resource Locator) to open to the public, and when an external-network apparatus accesses to a service indicated by URL, converts the access into a control command that can be directly interpreted by a relevant home apparatus to transmit.

Meanwhile, the method of item (2) needs to cope with how to transmit control commands specific to the home network such as AV/C command of IEEE1394 from a remote terminal such as a cellular telephone and a laptop computer. With respect to the foregoing, the technique disclosed in Japanese Laid-Open Patent Publication HEI11-187061 tries to solve the problem by downloading from a server on an external network anytime a control program (particularly, Java program) for directly transmitting such control commands specific to the network.

However, above methods (1) and (2) both have problems.

In the method of item (1), it is necessary for a gateway to hold a correspondence table between control commands received from external-network apparatuses and control commands that can be directly interpreted by home-network apparatuses. However, there are not a few types of AV/C commands of IEEE1394 or control commands of ECHONET. It is not preferable for a gateway to hold all the correspondence tables from the viewpoint of memory use amount. Further, whenever a new function is added to a home-network apparatus, it is necessary to specify the correspondence of control command between the external-apparatus and home-network apparatus, and to update the table of the gateway.

It is difficult to standardize the correspondence of commands to maintain compatibility between makers. Further, it is not easy for a gateway to detect a new service and update the table.

In the method of item (2), since a remote terminal transmits a control command that can be directly interpreted by a home-network apparatus, the load on a gateway is reduced. However, it is not easy for remote terminals such as cellular telephones and laptops to transmit such commands. The technique disclosed in Japanese Laid-Open Patent Publication HEI11-187061 proposes that a remote terminal downloads a Java program to execute. However, all the remote terminals are not expected to have resources and environments sufficient to execute the Java program. Further, there is a case that in order to take measures against improper Java programs with virus, functions are limited which can be achieved on a Java program.

### SUMMARY OF THE INVENTION

It is an object of the present invention to provide a method and apparatus enabling remote terminals to transmit control requests using general protocols without using a specific control program, while eliminating loads for converting the control requests on a gateway, and thereby achieve remote control.

In a remote control information opening method of the present invention, in a network system comprised of a controlled apparatus that is connected to a home network and interprets a home-network control request of home-network control command format to undergo control, a remote control terminal that is connected to an external network and transmits an external-network control request of external-network control command format different from the home-network control command format, a gateway apparatus that connects the home network and the external network, and a proxy server that converts in format, on the external network, the external-network control request into the home-network control request to transmit to the controlled apparatus, in order for the remote control terminal to remotely control the controlled apparatus, an apparatus identifier for identifying the controlled apparatus is assigned to the controlled apparatus, remote control information is generated which associates the apparatus identifier with a proxy server address indicative of an address on the external network of the proxy server responsible for the controlled apparatus, and the remote control information is open to the public on the external network.

According to this method, since the address of the proxy server to which the remote control terminal connects to control the controlled apparatus is open to the public on the external network, the remote control terminal is capable of acquiring the address to make the proxy server convert the format of the control request as a proxy for the terminal. Therefore, loads on the remote control terminal are reduced, and since the gateway apparatus does not need to convert the format, loads on the gateway apparatus are also reduced.

In the present invention, it may be possible to hold an expiration date of the proxy server address, and to acquire, when the expiration date expires, a new proxy server address to update the remote control information.

According to this method, a new valid proxy server address on public enables the remote control terminal to connect to a proxy server with reliability to make the proxy server convert the format.

In a remote control information registering method of the present invention, in a network system comprised of a controlled apparatus that is connected to a home network and interprets a home-network control request of home-network control command format to undergo control, a remote control terminal that is connected to an external network and transmits an external-network control request of external-network control command format different from the home-network control command format, a gateway apparatus that connects the home network and the external network, a proxy server that converts in format, on the external network, the external-network control request into the home-network control request to transmit to the controlled apparatus, and a remote control information opening apparatus that opens remote control information to the public on the external network where the remote control information associates an apparatus identifier for identifying the controlled apparatus with a proxy server address indicative of an address on the external network of the proxy server responsible for the controlled apparatus, in order for the remote control terminal to remotely control the controlled apparatus, the proxy server address of the proxy server responsible for the controlled apparatus is held and registered with the remote control information opening apparatus.

According to this method, since a proxy server address is registered with the remote control information opening apparatus when a new controlled apparatus is added, it is possible to reliably acquire the remote control information required for the remote control from the remote control terminal to the controlled apparatus.

Further, in the present invention, it may be possible to hold an expiration date of the proxy server address, and to acquire, when the expiration date expires, a new proxy server address.

According to this method, since a new valid proxy server address is acquired and registered with the remote control information opening apparatus, the remote control terminal is capable of connecting to a proxy server with reliability to make the proxy server convert the format.

In a remote control requesting method of the present invention, in a network system comprised of a controlled apparatus that is connected to a home network and interprets a home-network control request of home-network control command format to undergo control, a gateway apparatus that connects the home network and an external network, a proxy server that converts in format an external-network control request of external-network control command format available on an external network into the home-network control request to transmit to the controlled apparatus, and a remote control information opening apparatus that opens remote control information to the public on the external network where the remote control information associates an apparatus identifier for identifying the controlled apparatus with a proxy server address indicative of an address on the external network of the proxy server assigned to the controlled apparatus, in order for a remote control terminal to remotely control the controlled apparatus, the remote control terminal acquires the remote control information from the remote control information opening apparatus, transmits the external-network control request to the proxy server address indicated by the acquired remote control information, and makes the proxy server convert in format the external-network control request into the home-network control request and transmit the request to the controlled apparatus.

According to this method, it is possible to connect to the proxy server with the proxy server address indicated by the remote control information acquired from the remote control information opening apparatus, and to make the proxy server convert the format of the control request to the controlled apparatus. Therefore, loads on the remote control terminal are reduced, and since the gateway apparatus does not need to convert the format, loads on the gateway apparatus are also reduced.

In a remote control proxy method of the present invention, in a network system comprised of a controlled apparatus that is connected to a home network and interprets a home-network control request of home-network control command format to undergo control, a remote control terminal that is connected to an external network and transmits an external-network control request of external-network control command format different from the home-network control command format, a gateway apparatus that connects the home network and the external network, and a proxy information opening apparatus that opens control proxy information to the public on the external network where the control proxy information associates an apparatus identifier for identifying the controlled apparatus with a proxy server address on the external network assigned to the controlled apparatus, in order for the remote control terminal to remotely control the controlled apparatus, the external-network control request is received which the remote control terminal transmits to the proxy server address acquired from the proxy information opening apparatus, the received external-network control request is converted in format into the home-network control request, and the home-network control request is transmitted to the controlled apparatus.

According to this method, since the external-network control request transmitted from a remote control terminal to a proxy server address is converted in format into the home-network control request, loads on the remote control terminal are reduced, and since the gateway apparatus does not need to convert the format, loads on the gateway apparatus are also reduced.

In the present invention, it may be possible to encrypt the home-network control request to transmit to the controlled apparatus, and to designate either the gateway apparatus or the controlled apparatus as an apparatus for decrypting the encrypted home-network control request.

According to this method, since the external-network control request is not only converted in format into the home-network control request, but also is encrypted as a proxy for the remote control terminal, loads on the remote control terminal are reduced, and since the gateway apparatus does not need to encrypt the request, loads on the gateway apparatus are also reduced. Further, since either the gateway apparatus or the controlled apparatus is designated as an apparatus for decrypting the encrypted home-network control request, it is made possible to select the apparatus for decrypting the request as appropriate corresponding to performances of the controlled apparatus and gateway apparatus. For example, the gateway apparatus is designated when the controlled apparatus does not have the function of decrypting encrypted data or it is required to reduce loads on the controlled apparatus. Meanwhile, the controlled apparatus is designated when it is required to reduce loads on the gateway apparatus.

In an address converting method of the present invention, in a network system comprised of a controlled apparatus that is connected to a home network and interprets a home-network control request of home-network control command format to undergo control, a remote control terminal that is connected to an external network and transmits an external-network control request of external-network control command format different from the home-network control command format, a gateway apparatus that connects the home network and the external network, and a proxy server that converts in format, on the external network, the external-network control request into the home-network control request to transmit to the controlled apparatus, in order for the remote control terminal to remotely control the controlled apparatus, address conversion information is held which associates transmission source information comprised of a transmission source address indicative of an address on the external network of the proxy server and control specific codes assigned for each control content of the controlled apparatus to which the proxy server requests with post-conversion address information indicative of an address on the home network of the controlled apparatus, the home-network control request is received which is transmitted from the proxy server to the address on the external network of the gateway apparatus and which contains the home-network control request containing the transmission source address and a control specific code, the address conversion information is read which corresponds to the transmission source address and the control specific code, and according to the address conversion information, a transmission destination address of the home-network control request is converted from an address on the external networks into an address on the home network of the controlled apparatus indicated by the post-conversion address information.

According to this method, since the home-network control request is transferred to a desired controlled apparatus only by that the proxy server transmits the home-network control request containing the control specific code to an address of the gateway apparatus, the proxy server is capable of transmitting the home-network control request to the desired controlled apparatus without gasping the home-network address of the controlled apparatus.

In the present invention, it may be possible that the gateway apparatus identifies whether or not a received home-network control request is a control request to the gateway apparatus, and when the control request is to the gateway apparatus, executes the requested control over the gateway apparatus without transferring the home-network control request.

According to this method, it is possible to make the gateway apparatus control itself only by that the proxy server transmits the control request to the gateway apparatus to an address of the gateway apparatus in the same way as transmitting the home-network control request to the controlled apparatus.

Further in the present invention, when a content of the control request to the gateway apparatus is history information collection, the gateway apparatus may transmit history information containing at least one of execution results and execution states of control requested to the controlled apparatus.

According to this method, it is possible to make the gateway apparatus transmit history information only by that the proxy server transmits a history information transmission request to the gateway apparatus in the same way as transmitting the home-network control request to the controlled apparatus. Then, for example, it is possible to select either continuing or suspending a next home-network request from the history information.

Further, in the remote control proxy method of the present invention, it may be possible to collect requester information on requesters of the remote control, and to register the requester information with a requester information server that provides the information corresponding to an inquiry request from an outer terminal.

According to this method, using an external terminal, for example, it is made possible that sales representatives refer to the requester information on remote control of requesters to use in sales promotion of the controlled apparatus.

A remote control information opening apparatus of the present invention has an identifier assigning section that assigns an apparatus identifier for identifying a controlled apparatus to the controlled apparatus that is connected to a home network and interprets a home-network control request of home-network control command format to undergo control, a remote control information generating section that generates remote control information associating the apparatus identifier with a proxy server address indicative of an address on an external network of a proxy server that is responsible for the controlled apparatus and converts in format an external-network control request of external-network control command format different from the home-network control command format transmitted from a remote control terminal into the home-network control request to transmit to the controlled apparatus, and an opening section that opens the remote control information to the public on the external network.

According to this configuration, since the address of the proxy server to which the remote control terminal connects to control the controlled apparatus is open to the public on the external network, the remote control terminal is capable of acquiring the address to make the proxy server convert the format of the control request as a proxy for the terminal. Therefore, loads on the remote control terminal are reduced, and since the gateway apparatus does not need to convert the format, loads on the gateway apparatus are also reduced.

In the present invention, it may be possible to further have a proxy server address updating section which holds an expiration date of the proxy server address, and when the expiration date expires, acquires a new proxy server address to update the remote control information.

According to this configuration, a new valid proxy server address on public enables the remote control terminal to connect to a proxy server with reliability to make the proxy server convert the format.

A remote control information registering apparatus of the present invention has a proxy server address holding section that holds a proxy server address indicative of an address on an external network of a proxy server that converts in format an external-network control request into a home-network control request to transmit to a controlled apparatus, where the external control request has an external-network control command format different from a home-network control command format, and is transmitted from a remote control terminal connected to an external network to the controlled apparatus that is connected to a home network and interprets the home-network control request of the home-network control command format to undergo control, and a registering section that registers the proxy server address with a remote control information opening apparatus that opens remote control information to the public on the external network where the remote control information associates an apparatus identifier for identifying the controlled apparatus with the proxy server address indicative of the address on the external network of the proxy server responsible for the controlled apparatus.

According to this configuration, since a proxy server address is registered with the remote control information opening apparatus when a new controlled apparatus is added, it is possible to reliably acquire the remote control information required for the remote control from the remote control terminal to the controlled apparatus.

Further, in the present invention, it may be possible to further have a proxy server address acquiring section that holds an expiration date of the proxy server address, and when the expiration date expires, acquires a new proxy server address.

According to this configuration, since a new valid proxy server address is acquired and registered with the remote control information opening apparatus, the remote control terminal is capable of connecting to a proxy server with reliability to make the proxy server convert the format.

A remote control requesting apparatus of the present invention has a remote control information acquiring section that acquires remote control information from a remote control information opening apparatus that opens the remote control information to the public where the remote control information associates an apparatus identifier for identifying a controlled apparatus that is connected to a home network and interprets a home-network control request of home-network control command format to undergo control with a proxy server address indicative of an address on an external network of a proxy server that converts in format an external-network control request into the home-network control request to transmit to the controlled apparatus where the external control request has an external-network control command format different from the home-network control command format, and is transmitted to the controlled apparatus from a remote control terminal connected to the external network, and an external-network control request transmitting section which transmits the external-network control request to the proxy server address indicated by the acquired remote control information, and makes the proxy server convert in format the external-network control request into the home-network control request and transmit the request to the controlled apparatus.

According to this configuration, it is possible to connect to the proxy server with the proxy server address indicated by the remote control information acquired from the remote control information opening apparatus, and to make the proxy server convert the format of the control request to the controlled apparatus. Therefore, loads on the remote control terminal are reduced, and since the gateway apparatus does not need to convert the format, loads on the gateway apparatus are also reduced.

A remote control proxy server apparatus of the present invention has an external-network control request receiving section that receives an external-network control request transmitted to a proxy server address from a remote control terminal that is connected to an external network and acquires the proxy server address from a proxy information opening apparatus that opens control proxy information to the public on the external network where the control proxy information associates an apparatus identifier for identifying a controlled apparatus that is connected to a home network and interprets a home-network control request of home-network control command format to undergo control with the proxy server address on the external network of the proxy server apparatus assigned to the controlled apparatus, and a control request converting section which converts in format a received external-network control request into the home-network control request, and transmits the home-network control request to the controlled apparatus via a gateway apparatus that connects the external network and the home network.

According to this configuration, since the external-network control request transmitted from a remote control terminal to a proxy server address is converted in format into the home-network control request, loads on the remote control terminal are reduced, and since the gateway apparatus does not need to convert the format, loads on the gateway apparatus are also reduced.

In the present invention, it may be possible to further have an encryption end terminal designating section which encrypts the home-network control request to transmit to the controlled apparatus, and designates either the gateway apparatus or the controlled apparatus as an apparatus for decrypting the encrypted home-network control request.

According to this configuration, since the external-network control request is not only converted in format into the home-network control request, but also is encrypted as a proxy for the remote control terminal, loads on the remote control terminal are reduced, and since the gateway apparatus does not need to encrypt the request, loads on the gateway apparatus are also reduced. Further, since either the gateway apparatus or the controlled apparatus is designated as an apparatus for decrypting the encrypted home-network control request, it is made possible to select the apparatus for decrypting the request as appropriate corresponding to performances of the controlled apparatus and gateway apparatus. For example, the gateway apparatus is designated when the controlled apparatus does not have the function of decrypting encrypted data or it is required to reduce loads on the controlled apparatus. Meanwhile, the controlled apparatus is designated when it is required to reduce loads on the gateway apparatus.

An address converting apparatus of the present invention converts a transmission destination address of a home-network control request from an address on an external network into an address on a home network in a network system comprised of a controlled apparatus that is connected to the home network and interprets the home-network control request of home-network control command format to undergo control, a remote control terminal that is connected to the external network and transmits an external-network control request of external-network control command format different from the home-network control command format, a gateway apparatus that connects the home network and the external network, and a proxy server that converts in format, on the external network, the external-network control request into the home-network control request to transmit to the controlled apparatus, and has an address conversion information holding section that holds address conversion information associating transmission source information comprised of a sender address indicative of an address on the external network of the proxy server and control specific codes assigned for each control content of the controlled apparatus to which the proxy server requests with post-conversion address information indicative of an address on the home network of the controlled apparatus, a home-network control request receiving section that receives the home-network control request which is transmitted from the proxy server to the address on the external network of the gateway apparatus and which contains the home-network control request containing the transmission source address and the control specific code, and an address converting section which reads the address conversion information that corresponds to the transmission source address and the control specific code, and according to the address conversion information, converts a transmissions destination address of the home-network control request into an address on the home-network of the controlled apparatus indicated by the post-conversion address information.

According to this configuration, since the home-network control request is transferred to a desired controlled apparatus only by that the proxy server transmits the home-network control request containing the control specific code to an address of the gateway apparatus, the proxy server is capable of transmitting the home-network control request to the desired controlled apparatus without gasping the home-network address of the controlled apparatus.

In the present invention, it may be possible to further have a control request identifying section that identifies whether or not a received home-network control request is a control request to the gateway apparatus, and a control executing section which when the control request is to the gateway apparatus, executes the requested control over the gateway apparatus without transferring the home-network control request.

According to this configuration, it is possible to make the gateway apparatus control itself only by that the proxy server transmits the control request to the gateway apparatus to an address of the gateway apparatus in the same way as transmitting the home-network control request to the controlled apparatus.

Further in the present invention, when a content of the control request to the gateway apparatus is history information collection, the control executing section may transmit history information containing at least one of execution results and execution states of control requested to the controlled apparatus.

According to this configuration, it is possible to make the gateway apparatus transmit history information only by that the proxy server transmits a history information transmission request to the gateway apparatus in the same way as transmitting the home-network control request to the controlled apparatus. Then, for example, it is possible to select either continuing or suspending a next home-network request from the history information.

Further, in the remote control proxy server apparatus of the present invention, it may be possible to further have a requester information collecting section that collects requester information on requesters of the remote control, and a requester information registering section that registers the requester information with a requester information server that provides the information corresponding to an inquiry request from an outer terminal.

According to this configuration, using an external terminal, for example, it is made possible that sales representatives refer to the requester information on remote control of requesters to use in sales promotion of the controlled apparatus.

A remote control information opening program of the present invention makes a computer function as an identifier assigning section that assigns an apparatus identifier for identifying a controlled apparatus to the controlled apparatus that is connected to a home network and interprets a home-network control request of home-network control command format to undergo control, a remote control information generating section that generates remote control information associating the apparatus identifier with a proxy server address indicative of an address on the external network of a proxy server that is responsible for the controlled apparatus and converts an external-network control request of external-network control command format different from the home-network control command format transmitted from a remote control terminal into the home-network control request to transmit to the controlled apparatus, and an opening section that opens the remote control information to the public on the external network.

According to this program, since the address of the proxy server to which the remote control terminal connects to control the controlled apparatus is open to the public on the external network, the remote control terminal is capable of acquiring the address to make the proxy server convert the format of the control request as a proxy for the terminal. Therefore, loads on the remote control terminal are reduced, and since the gateway apparatus does not need to convert the format, loads on the gateway apparatus are also reduced.

In this program, it may be possible to further make the computer function as a proxy server address updating section that holds an expiration date of the proxy server address, and when the expiration date expires, acquires a new proxy server address to update the remote control information.

According to this program, a new valid proxy server address on public enables the remote control terminal to connect to a proxy server with reliability to make the proxy server convert the format.

A remote control information registering program of the present invention makes a computer function as a proxy server address holding section that holds a proxy server address indicative of an address on an external network of a proxy server that converts in format an external-network control request into a home-network control request to transmit to a controlled apparatus, where the external control request has an external-network control command format different from a home-network control command format, and is transmitted from a remote control terminal connected to the external network to a controlled apparatus that is connected to a home network and interprets the home-network control request of home-network control command format to undergo control, and a registering section that registers the proxy server address with a remote control information opening apparatus that opens remote control information to the public on the external network where the remote control information associates an apparatus identifier for identifying the controlled apparatus with the proxy server address indicative of the address on the external network of the proxy server responsible for the controlled apparatus.

According to this program, since a proxy server address is registered with the remote control information opening apparatus when a new controlled apparatus is added, it is possible to reliably acquire the remote control information required for the remote control from the remote control terminal to the controlled apparatus.

Further, in this program, it may be possible to further make the computer as a proxy server address acquiring section that holds an expiration date of the proxy server address, and when the expiration date expires, acquires a new proxy server address.

According to this program, since a new valid proxy server address is acquired and registered with the remote control information opening apparatus, the remote control terminal is capable of connecting to a proxy server with reliability to make the proxy server convert the format.

A remote control requesting program of the present invention makes a computer function as a remote control information acquiring section that acquires remote control information from a remote control information opening apparatus that opens the remote control information to the public where the remote control information associates an apparatus identifier for identifying a controlled apparatus that is connected to a home network and interprets a home-network control request of home-network control command format to undergo control with a proxy server address indicative of an address on an external network of a proxy server that converts in format an external-network control request into the home-network control request to transmit to the controlled apparatus where the external control request has an external-network control command format different from the home-network control command format, and is transmitted to the controlled apparatus from a remote control terminal connected to the external network, and an external-network control request transmitting section that transmits the external-network control request to the proxy server address indicated by the acquired remote control information, and makes the proxy server convert in format the external-network control request into the home-network control request and transmit the request to the controlled apparatus.

According to this program, it is possible to connect to the proxy server with the proxy server address indicated by the remote control information acquired from the remote control information opening apparatus, and to make the proxy server convert the format of the control request to the controlled apparatus. Therefore, loads on the remote control terminal are reduced, and since the gateway apparatus does not need to convert the format, loads on the gateway apparatus are also reduced.

A remote control proxy server program of the present invention makes a computer function as an external-network control request receiving section that receives an external-network control request transmitted to a proxy server address from a remote control terminal that is connected to an external network and acquires the proxy server address from a proxy information opening apparatus that opens control proxy information to the public on the external network where the control proxy information associates an apparatus identifier for identifying a controlled apparatus that is connected to a home network and interprets a home-network control request of home-network control command format to undergo control with the proxy server address on the external network of the proxy server apparatus assigned to the controlled apparatus, and a control request converting section which converts in format a received external-network control request into a home-network control request, and transmits the home-network control request to the controlled apparatus via a gateway apparatus that connects the external network and the home network.

According to this program, since the external-network control request transmitted from a remote control terminal to a proxy server address is converted into the home-network control request, loads on the remote control terminal are reduced, and since the gateway apparatus does not need to convert the format, loads on the gateway apparatus are also reduced.

In this program, it may be possible to further make the computer function as an encryption end terminal designating section which encrypts the home-network control request to transmit to the controlled apparatus, and designates either the gateway apparatus or the controlled apparatus as an apparatus for decrypting the encrypted home-network control request.

According to this program, since the external-network control request is not only converted in format into the home-network control request, but also is encrypted as a proxy for the remote control terminal, loads on the remote control terminal are reduced, and since the gateway apparatus does not need to convert the format, loads on the gateway apparatus are also reduced. Further, since either the gateway apparatus or the controlled apparatus is designated as an apparatus for decrypting the encrypted home-network control request, it is made possible to select the apparatus for decrypting the request as appropriate corresponding to performances of the controlled apparatus and gateway apparatus. For example, the gateway apparatus is designated when the controlled apparatus does not have the function of decrypting encrypted data or it is required to reduce loads on the controlled apparatus. Meanwhile, the controlled apparatus is designated when it is required to reduce loads on the gateway apparatus.

An address converting program of the present invention makes a computer convert a transmission destination address of a home-network control request from an address on an external network into an address on a home network in a network system comprised of a controlled apparatus that is connected to the home network and interprets a home-network control request of home-network control command format to undergo control, a remote control terminal that is connected to the external network and transmits an external-network control request of external-network control command format different from the home-network control command format, a gateway apparatus that connects the home network and the external network, and a proxy server that converts in format, on the external network, the external-network control request into the home-network control request to transmit to the controlled apparatus, and makes the computer function as an address conversion information holding section that holds address conversion information associating transmission source information comprised of a sender address indicative of an address on the external network of the proxy server and control specific codes assigned for each control content of the controlled apparatus to which the proxy server requests with post-conversion address information indicative of an address on the home network of the controlled apparatus, a home-network control request receiving section that receives the home-network control request which is transmitted from the proxy server to the address on the external network of the gateway apparatus and which contains the home-network control request containing the transmission source address and a control specific code, and an address converting section which reads the address conversion information that corresponds to the transmission source address and the control specific code, and according to the address conversion information, converts the transmission destination address of the home-network control request into an address on the home-network of the controlled apparatus indicated by the post-conversion address information.

According to this program, since the home-network control request is transferred to a desired controlled apparatus only by that the proxy server transmits the home-network control request containing the control specific code to an address of the gateway apparatus, the proxy server is capable of transmitting the home-network control request to the desired controlled apparatus without gasping the home-network address of the controlled apparatus.

In this program, it may be possible to further make the computer function as a control request identifying section that identifies whether or not a received home-network control request is a control request to the gateway apparatus, and a control executing section which when the control request is to the gateway apparatus, executes the requested control over the gateway apparatus without transferring the home-network control request.

According to this program, it is possible to make the gateway apparatus control itself only by that the proxy server transmits the control request for the gateway apparatus to an address of the gateway apparatus in the same way as transmitting the home-network control request to the controlled apparatus.

Further in this program, when a content of the control request to the gateway apparatus is history information collection, the control executing section may transmit history information containing at least one of execution results and execution states of control requested to the controlled apparatus.

According to this program, it is possible to make the gateway apparatus transmit history information only by that the proxy server transmits a history information transmission request to the gateway apparatus in the same way as transmitting the home-network control request to the controlled apparatus. Then, for example, it is possible to select either continuing or suspending a next home-network request from the history information.

Further, in the remote control proxy server program of the present invention, it may be possible to further make the computer function as a requester information collecting section that collects requester information on requesters of the remote control, and a requester information registering section that registers the requester information with a requester information server that provides the information corresponding to an inquiry request from an outer terminal.

According to this program, using an external terminal, for example, it is made possible that sales representatives refer to the requester information on remote control of requesters to use in sales promotion of the controlled apparatus.

Further, the present invention includes computer readable storage media that store the above programs.

### BRIEF DESCRIPTION OF THE DRAWINGS

The above and other objects and features of the invention will appear more fully hereinafter from a consideration of the following description taken in connection with the accompanying drawing wherein one example is illustrated by way of example, in which;

FIG. 1 is a schematic diagram illustrating a network system using a home-network apparatus control method according to Embodiment 1 of the present invention;

FIG. 2 is a block diagram illustrating functions of a proxy server according to Embodiment 1;

FIG. 3 is a block diagram illustrating functions of a gateway according to Embodiment 1;

FIG. 4A,4B are a sequence diagram illustrating procedures performed between apparatuses in the network system using the home-network apparatus control method according to Embodiment 1;

FIG. 5 is a diagram illustrating an example of a home page for selection screen displayed on a remote terminal in the home-network apparatus control method according to Embodiment 1;

FIG. 6 is a diagram illustrating an example of a home page for control item screen displayed on a remote terminal in the home-network apparatus control method according to Embodiment 1;

FIG. 7 is a diagram illustrating an example of a home page for control setting screen displayed on a remote terminal in the home-network apparatus control method according to Embodiment 1;

FIG. 8(a) is a diagram illustrating an example of command transfer setting request message for home-network apparatus in the home-network apparatus control method according to Embodiment 1;

FIG. 8(b) is a diagram illustrating an example of command transfer setting request message for gateway in the home-network apparatus control method according to Embodiment 1;

FIG. 9 is a diagram illustrating an example of an address conversion information table in the home-network apparatus control method according to Embodiment 1;

FIG. 10 is a diagram illustrating an example of a home page for notification screen in the home-network apparatus control method according to Embodiment 1;

FIG. 11 is a sequence diagram illustrating procedures performed between apparatuses in the network system using the home-network apparatus control method according to Embodiment 1;

FIG. 12 is a sequence diagram illustrating procedures performed between apparatuses in a network system using a home-network apparatus control method according to Embodiment 2 of the present invention;

FIG. 13 is a sequence diagram illustrating procedures performed between apparatuses in a network system using a home-network apparatus control method according to Embodiment 3 of the present invention;

FIG. 14 is a sequence diagram illustrating procedures performed between apparatuses in a network system using a home-network apparatus control method according to Embodiment 4 of the present invention; and

FIG. 15 is another sequence diagram illustrating procedures performed between apparatuses in the network system using the home-network apparatus control method according to Embodiment 4.

### DETAILED DESCRIPTION OF THE PREFERRED EMBODIMENTS

Embodiments of the present invention will be described below specifically with reference to accompanying drawings.

(Embodiment 1)

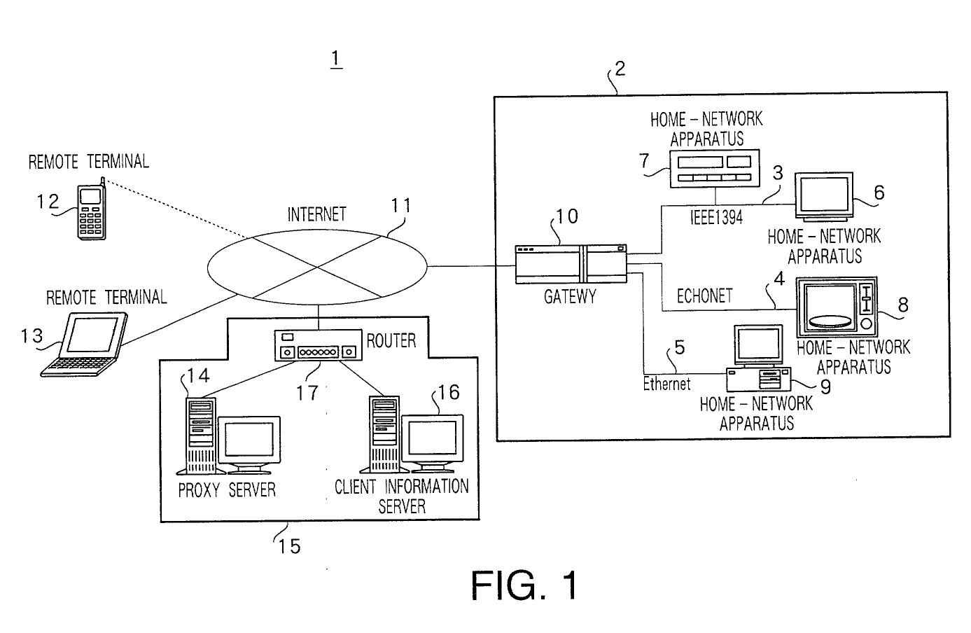

FIG. 1 is a schematic diagram illustrating a network system using a home-network apparatus control method according to Embodiment 1 of the present invention;

In network system 1, home-network area 2 is constructed of a plurality of different types of home networks, i.e., IEEE1394 network 3, ECHONET network 4 and Ethernet (R) network 5. IEEE1394 network 3 is to accommodate AV apparatuses, and in this embodiment 1 connected to digital TV 6 and VTR 7 as home-network apparatuses. ECHONET network 4 is to accommodate home appliances, and in this embodiment connected to microwave oven 8 as a home-network apparatus. Ethernet (R) network 5 is to accommodate PC apparatuses such as a personal computer (PC) and printer, and in this embodiment, connected to PC9. Hereafter, IEEE 1394 network 3, ECHONET network 4 and Ethernet (R) network 5 are both referred to as a “home network”.

Home-network apparatuses are each provided with an interface and communication protocol conforming to the specification of a home network to which the apparatus is connected. Further, in Embodiment 1, since control request commands are encrypted as described later, the apparatuses need to be provided with a section for decrypting the commands.

Home networks 3, 4 and 5 are connected to gateway 10. Gateway 10 is a relay apparatus provided with interfaces respectively for home networks 3, 5 and 5, and an interface for the internet 11. Gateway 10 mutually converts protocols different between the networks to implement data transfer. Each house is provided with, for example, a single Gateway 10.

The internet 11 that is an external network is connected to cellular telephone 12 and desktop PC 13 (hereafter referred to as a remote terminal) as remote terminals for remotely controlling home-network apparatuses. It is only required for remote terminals to have the function of connecting to the internet, and the function of communicating HTTP commands with proxy server 14 as described later. Another examples of remote terminals are portable personal information terminal (PDA) provided with the communication function and a telephone with the internet function such as an L mode.

The internet 11 is connected to proxy server 14 and client information server 16 via router 17 provided in manufacturer area 15. Proxy server 14 receives a control request to a home-network apparatus from a remote terminal and actually controls the home-network apparatus as a proxy for the remote terminal. Meanwhile, client information server 16 manages information of clients having home-network apparatuses registered therewith. Proxy server 14 and client information server 16 will be described specifically below.

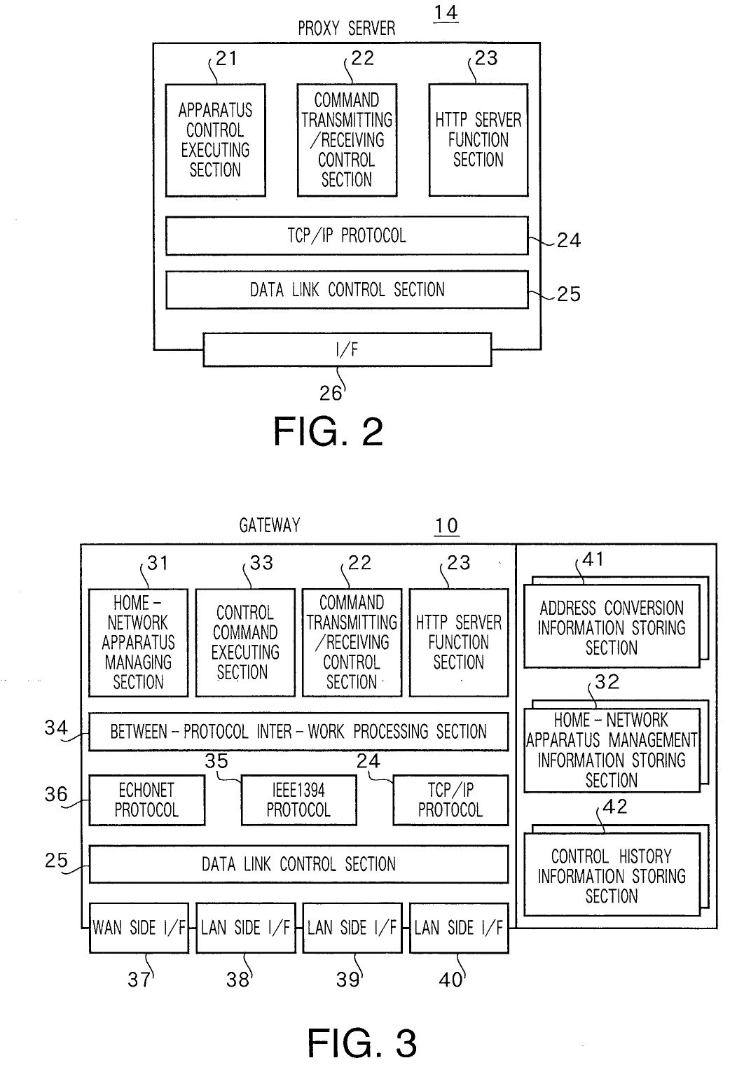

FIG. 2 is a block diagram illustrating functions of the proxy server according to Embodiment 1. In proxy server 14, apparatus control executing section 21 primarily executes operations required for home-network apparatus control in Embodiment 1 in proxy server 14. Specifically, the section 21 creates a home page and controls screens on a Web basis to transmit to a remote terminal, determines whether or not control can be executed upon receiving a control request from a remote terminal, retrieves a control command that can be directly interpreted by a home-network apparatus, transmits/receives commands to/from command transmitting/receiving control section 22, and updates information of client information server 16.

Command transmitting/receiving control section 22 assembles a control command corresponding to protocol (for example, IEEE1394 or ECHONET) applied to the home network to which the home-network apparatus is connected.

HTTP server function section 23 transmits a control screen to a remote terminal using the HTTP protocol.

Proxy server 14 is provided with TCP/IP protocol stack 24, data link control section 25 and network interface 26 as basic network functions required to connect to the internet.

TCP/IP protocol stack 24 includes schemes (such as IPsec and SSL (Secure Sockets Layer)) to implement user authentication for authenticating a user and encrypting transmission data.

FIG. 3 is a block diagram illustrating functions of the gateway according to Embodiment 1. Sections having the same functions as in proxy server 14 are assigned the same reference numerals to omit descriptions thereof.

In gateway 10, home-network apparatus managing section 31 collects information on attributes and states of home-network apparatuses to store in home-network apparatus management information storing section 32.

Control command executing section 33 executes a control command when a remote terminal transmits the control command to gateway 10. Specifically, the section 33 handles command transfer setting requests from remote terminals, collects control history information, etc.

Between-protocol inter-work processing section 34 implements processing on the inter-work between protocols (specifically, TCP/IP, IEEE1394 and ECHONET) used on a plurality of home networks that gateway 10 handles.

IEEE1394 protocol stack 35 and ECHONET protocol stack 36 are protocol groups required for communications respectively on IEEE1394 network 3 and ECHONET network 4.

WAN side interface (I/F) 37 is to connect to the internet 11, while LAN side interfaces 38, 39 and 40 are to connect to the home networks.

Gateway 10 implements the functions as a gateway, while storing various information required for implementing the home-network control of the present invention. Address conversion information storing section 41 stores information on address conversion required for transmitting packets input from one of interfaces 37 to 40 to another interface using a different protocol. Home-network apparatus management information storing section 32 stores the information on attributes and states of home-network apparatuses. Control history information storing section 42 stores information on histories of various operations that gateway 10 performs.

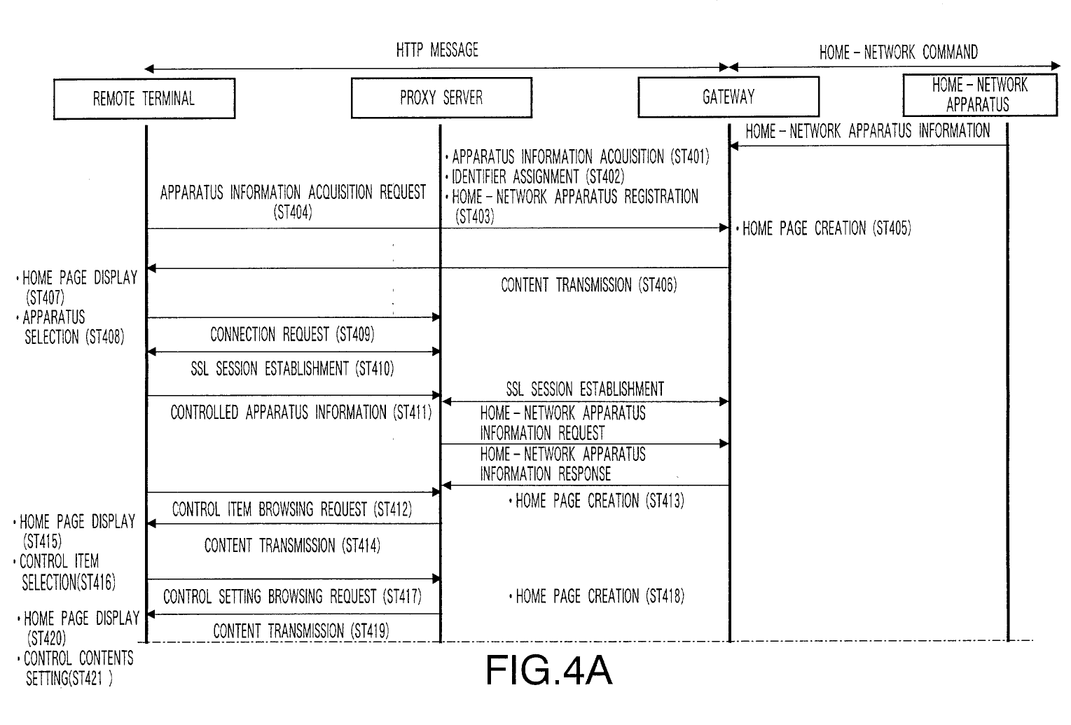

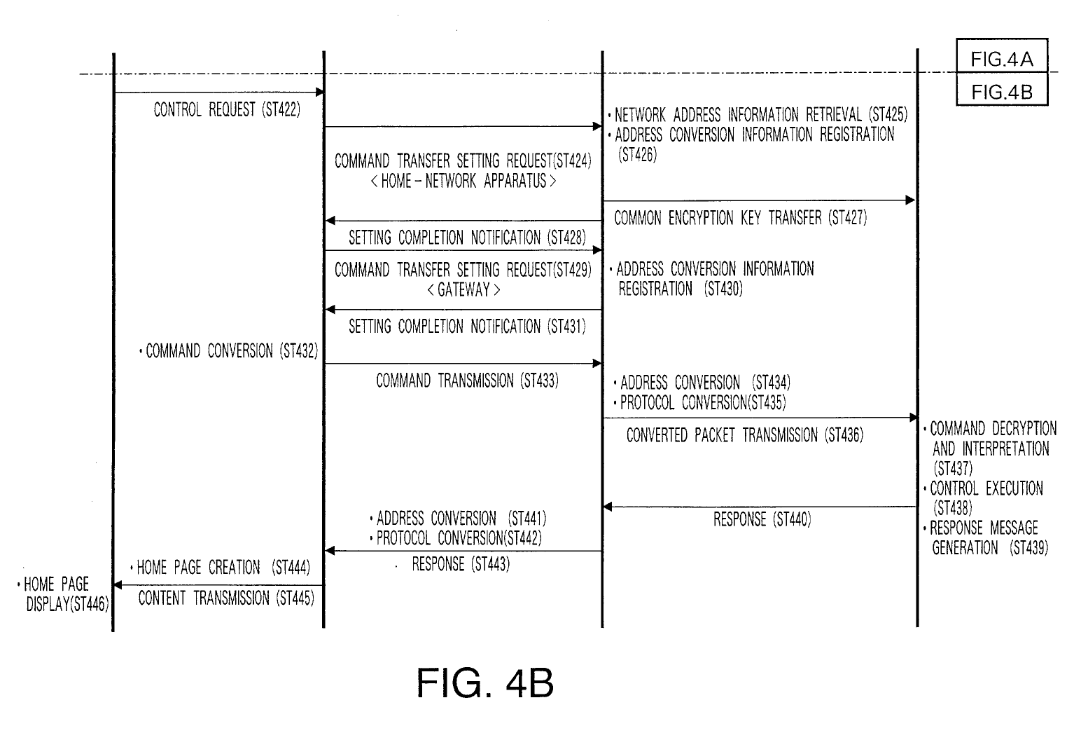

FIG. 4A,4B are a sequence diagram illustrating procedures performed between apparatuses in the network system using the home-network apparatus control method according to Embodiment 1.

Gateway 10 checks home-network apparatuses connected to the home networks at regularly time intervals, and when detecting a new home-network apparatus, collects information (apparatus information) on an attribute and state of the home-network apparatus (ST401). The apparatus information specifically includes:

Apparatus name;

URL of proxy server 14;

Expiration date of URL;

Address on the home network (hereafter, referred to as a home-network address); and

MAC address.

Next, gateway 10 assigns a home-network apparatus identifier easy to understand for an operator of a remote terminal to the detected remote terminal (ST402). The home-network apparatus identifier is determined, for example, to be “VTR 1” using an apparatus name, but is not limited in particular. Gateway 10 associates the assigned home-network apparatus identifier with these acquired information to generate home-network apparatus management information, and registers the information with home-network apparatus management information storing section 32 (ST403).

According to procedures up to this point, gateway 10 assigns the home-network apparatus identifier to the home-network apparatus, and associates URL of proxy server 14 and expiration date of URL with the home-network apparatus identifier to hold.

When a remote terminal controls a home-network apparatus, the remote terminal first acquires information of the home-network apparatus from gateway 10. As illustrated in FIG. 4A,4B, the remote terminal transmits an information acquisition request message for the home-network apparatus to gateway 10 using the HTTP protocol (ST404). Upon receiving the information acquisition request message, gateway 10 refers to home-network apparatus management information storing section 32, and generates a content of home page for selection screen indicating home-network apparatuses registered with home-network apparatus management information storing section 32 (ST405). Gateway 10 transmits a generated data file (for example, an HTML file) of the content of home page for selection screen to the remote terminal using the HTTP protocol (ST406).

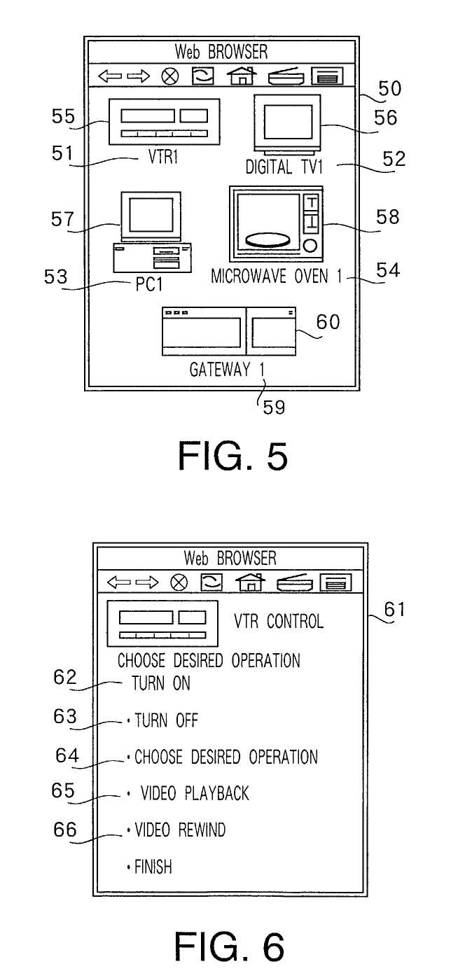

The remote terminal displays the received data file on a display using a Web browser (ST407). FIG. 5 is a diagram illustrating an example of the home page for selection screen displayed on a remote terminal in the home-network control method according to Embodiment 1. As illustrated in FIG. 5, on home page for selection screen 50 are displayed pairs of home-network apparatus identifiers 51 to 54 assigned to respective home-network apparatuses, and icons 55 to 58 prepared corresponding to types of the home-network apparatus. In this example, for gateway 10, identifier 59 and icon 60 are displayed.

The operator of the remote terminal selects a home-network apparatus to control (in this example, VTR) (ST408). The operator clicks home-network apparatus identifier (VTR 1) 51 or icon 55 of the selected home-network apparatus (VTR). Since clicking home-network apparatus identifier 51 or icon 55 links to URL of proxy server 14 responsible for the home-network apparatus, the remote terminal transmits a connection request to proxy server 14 based on URL (ST409).

Upon receiving a connection request from the remote terminal (ST409), proxy server 104 establishes an SSL session with the remote terminal (ST410). At this point, the remote terminal and proxy server 14 exchange messages to which attached is a certification for certifying its identity to mutually authenticate its communicating party, and negotiate to determine an encryption algorithm for use in communications. Further, the remote terminal transmits a common encryption key for use in decrypting encrypted data. The following communications are performed using this SSL session.

Next, the remote terminal transmits to proxy server 14 controlled apparatus information containing an IP address of gateway 10 and the home-network apparatus identifier (VTR 1) of the home-network apparatus (VTR) (ST411). At this point, as illustrated in FIG. 4A,4B, proxy server 14 establishes an SSL session for gateway 10. Proxy server 14 exchanges the common encryption key, and transmits an electronic certification obtained from a third party of a certification organization to gateway 10. Based on the received electronic certification, gateway 10 authenticates whether the party, i.e., proxy server 14 that intends to control the home-network apparatus, has the creditability. Using this SSL session, proxy server 14 acquires types of home-network apparatuses and types of controls executable for respective apparatuses using “home-network apparatus information request”.

Then, the remote terminal requests a control item screen for displaying control items of the home-network apparatus to proxy server 14 using the HTTP protocol (ST412). In response thereto, based on the information acquired from the home-network apparatus request, proxy server 14 generates a content of home page for control item screen for displaying control items of the home-network apparatus (VTR) (ST413). Next, proxy server 14 transmits a data file of the content of home page for control item screen to the remote terminal (ST414).

The remote terminal displays the received data file on the display using the Web browser (ST415). FIG. 6 is a diagram illustrating an example of the home page for control item screen displayed on the remote terminal in the home-network control method according to Embodiment 1. As illustrated in FIG. 6, on home page for control item screen 61 are listed control items 62 to 66 of the home-network apparatus (VTR) controllable from the remote terminal. Control items 62 to 66 are each linked to URL of a respective home page for control setting screen for setting control contents.

When the operator of the remote terminal clicks control item 64 after determining the item (in this example, recording) for the control (ST416), the remote terminal transmits an HTTP request to proxy server 14 based on linked URL (ST417).

In response thereto, proxy server 14 generates a content of the home page for control setting screen for use in setting control contents of the control item (recording), based on the information acquired from the home-network apparatus information request (ST418). Proxy server 14 transmits a data file of the content of the home page for control setting screen to the remote terminal (ST419).

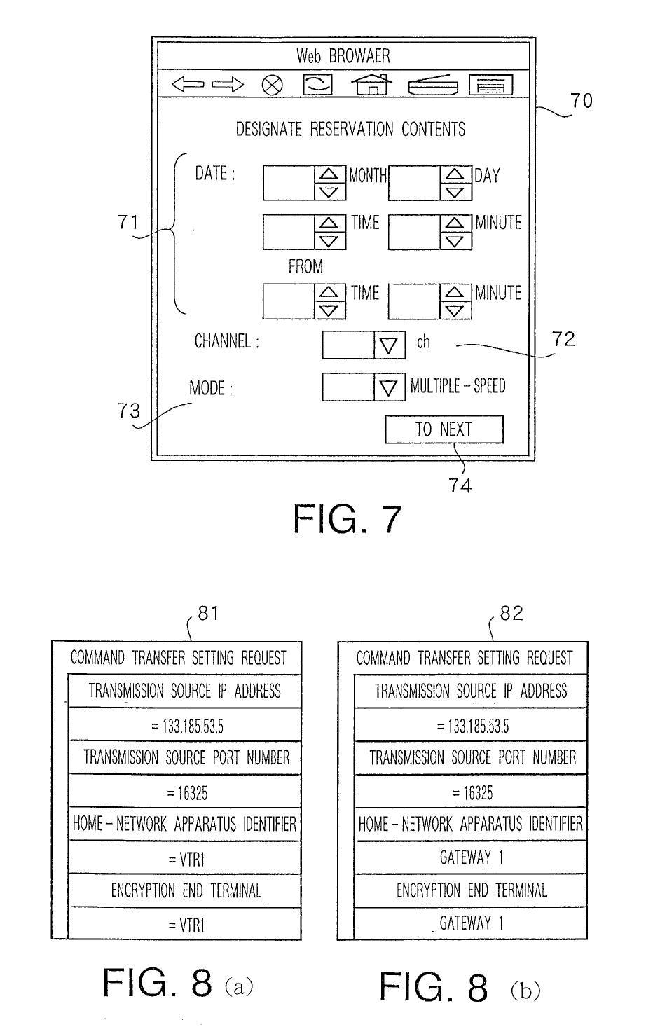

The remote terminal displays the received data file on the display using the Web browser (ST420). FIG. 7 is a diagram illustrating an example of the home page for control setting screen displayed on the remote terminal in the home-network control method according to Embodiment 1.

On home page for control setting screen 70 are prepared reserve data setting item 71 for setting date to reserve recording, channel setting item 72 for setting a channel for the recording, and mode setting item 73 for setting a recording speed mode for the recording. After setting required matters in item 71 to 73, the operator clicks button 74 of “to next”. Then, the remote terminal generates a control request message containing all information required for the controlling the home-network apparatus, and transmits the message to proxy server 14 using the HTTP protocol (ST422).

According to the procedures as described above, proxy server 14 receives a control request to the home-network apparatus (VTR) from the remote terminal. Since the procedures between the remote terminal and proxy server 14 are performed using the HTTP protocol on the TCP/IP protocol, it is only required for the remote terminal to be provided with the TCP/IP protocol stack (including authentication and encryption functions) and a Web browser as an HTTP client.

The control over the home-network apparatus will be described below which is performed by proxy server 14 via gateway 10. Upon receiving the final control request message from the remote terminal as described above (ST422), proxy server 14 establishes an SSL session with gateway 10 according to the same procedure in ST410.

Then, proxy server 14 transmits command transfer setting request message 81 illustrated in FIG. 8(a) to gateway 10 using the HTTP protocol (ST424). Items on the command transfer setting request massage indicate as described below:

Transmission source IP address: IP address of proxy server 14

Transmission source port number: Port number for specifying a home-network apparatus control program operating on proxy server 14

Home-network apparatus identifier: Identifier of a home-network apparatus selected in a remote terminal

Encryption end terminal: Either the home-network apparatus or gateway 10 is designated to decrypt an encrypted control command transmitted from proxy server 14 to gateway 10. In this example, “VTR 1” is designated.

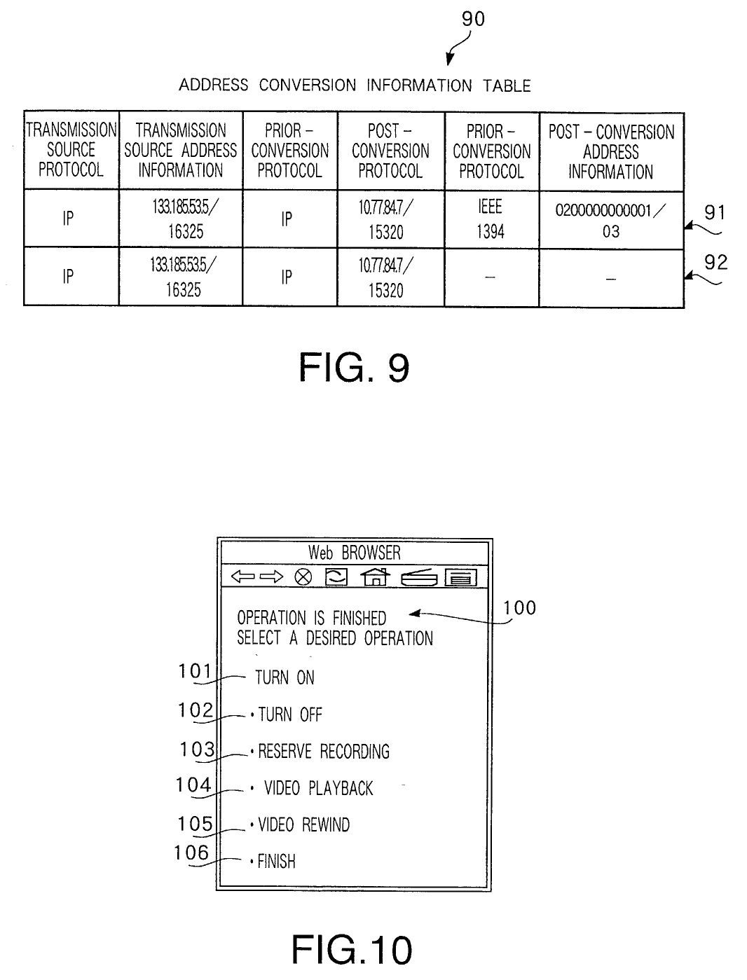

Gateway 10 having received the command transfer setting request message refers to home-network apparatus management information storing section 32 illustrated in FIG. 3, and retrieves the network address information corresponding to the home-network apparatus identifier in the message to read (ST425). Based on information in the message and the network address information, proxy sever 14 generates address conversion information 91 as illustrated in address conversion table 90, line 1 in FIG. 9 to register with address conversion information storing section 41 (ST426). When the address conversion information is already present, the information is updated. The address conversion information is composed of following values:

Transmission source protocol: Network protocol used in transmitting from a transmission source (proxy server 14); IP protocol in this example

Transmission source address information: IP address/port number of proxy server 14 designated in the command transfer setting request message

Prior-conversion protocol: Network protocol prior to the conversion in gateway 10; IP protocol in this example;

Prior-conversion address information: IP address of gateway 10 and a port number for specifying control command executing section 33 operating on gateway 10

Post-conversion protocol: Network protocol used in the home network corresponding to the home-network apparatus identifier; IEEE1394 in this example

Post-conversion address information: Address information specific to the network on which the home-network apparatus exists; herein, as an example, GUID and node ID on the IEEE1394 network are set.

Since in the command transfer setting request message illustrated in FIG. 8(a) the home-network apparatus (VTR) is set as an encryption end terminal, gateway 10 transfers the acquired common encryption key to the home-network apparatus (ST427). It is thus possible for the home-network apparatus to interpret the encrypted control command.

In this way, the setting is completed for proxy server 14 to transmit the control command to the home-network apparatus. After completing the setting, gateway 10 notifies proxy server 14 of completion of the setting (ST428).

After finishing the command transfer setting for the home-network apparatus (VTR 1), proxy server 14 performs command transfer setting for gateway 10 (ST429). Command transfer setting request message 82 illustrated in FIG. 8(b) is for the remote terminal to control gateway 10. Therefore, the home-network apparatus identifier is set at “gateway 1” that is an identifier of gateway 10. Further, the encryption end terminal is set at gateway 10. Therefore, based on the message, gateway 10 generates address conversion information 92 illustrated in address conversion information table 90, line 2 in FIG. 9. However, since an apparatus targeted for the control is gateway 10, columns of post-conversion protocol and post-conversion address information are blank. In this way, as in the case that an apparatus targeted for the control is a home-network apparatus, the setting is completed for proxy server 14 to transmit a control command to gateway 10 (ST430).

When the setting is thus completed, gateway 10 notifies proxy server 10 of completion of the setting (ST431).

After the command transfer setting is finished as described above, proxy serer 14 converts the control request in ST422 into a control request command (ST432) to transmit to gateway 10 (ST433). More specifically, proxy server 14 converts in format the control request received as an HTTP request into the control request command that can be directly interpreted by the home-network apparatus to transmit. The recording instructing command is encrypted using the common encryption key, then given a header of IP packet, and transmitted over the internet 11 to gateway 10 as a destination.

In addition, in this example, the control request command is the recording instructing command, more specifically, using an AV/C command of IEEE1394.

Upon receiving the IP-packet control request command (recording instructing command), gateway 10 refers to address conversion information storing section 41 illustrated in FIG. 3, retrieves the address conversion information on line 1 based on a transmission source address and port number contained in the IP packet to read. According to the read address conversion information, gateway 10 converts the transmission destination address of the IP packet (ST434). Further, gateway 10 rewrites the header information of the packet from IP to IEEE1394 to perform protocol conversion (ST435), and then transmits converted packets (recording instructing command) over the IEEE1394 network (ST436).

The home-network apparatus (VTR 1) receives the packets containing the control request command (recording instructing command), decrypts an encrypted payload of the packet using the common encryption key acquired in ST427, and interprets the recording instructing command (ST437). Then, the home-network apparatus executes the control (recording reservation) according to a result of the interpretation (ST438).

After finishing the control, the home-network apparatus generates a response message to be transmitted to proxy server 14 (ST439). The generated response message is transmitted to proxy server 14 according to command transfer (ST440, ST441, ST442 and ST443). Based on the response message, proxy server 14 generates a contentof homepagefornotificationscreenfornotifying the control completion as illustrated in FIT.10 (ST444). Then, as a response to the control request in ST422, proxy server 14 transmits a data file of the content of home page for notification screen to the remote terminal (ST445). Upon receiving the data file, the remote terminal opens the data file on the Web browser to display, and notifies the operation of the completion of the control (ST446).

In addition, this example explains the case where when receiving packets containing a control request command, a home-network apparatus accepts the control, and executes the processing sequentially (ST437 to ST439), i.e., the case where the control request succeeds. However, there is a case where a home-network apparatus rejects a control request and does not executes the control, i.e., the case where the control request fails. For example, when a home-network apparatus executes other processing which does not permit the control requested for the apparatus to be executed, the control request fails. More specifically, when a control request is recording reservation and the home-network apparatus (VTR 1) is controlled by another terminal (for example, PC 9), the apparatus cannot reserve the recording, and rejects the recording reservation. In such a case, the apparatus generates a response message indicative of control request rejection (hereafter, referred to as an NG response message) to transmit. Thus, according to Embodiment 1, the operation is capable of knowing whether a control request succeeds or fails.

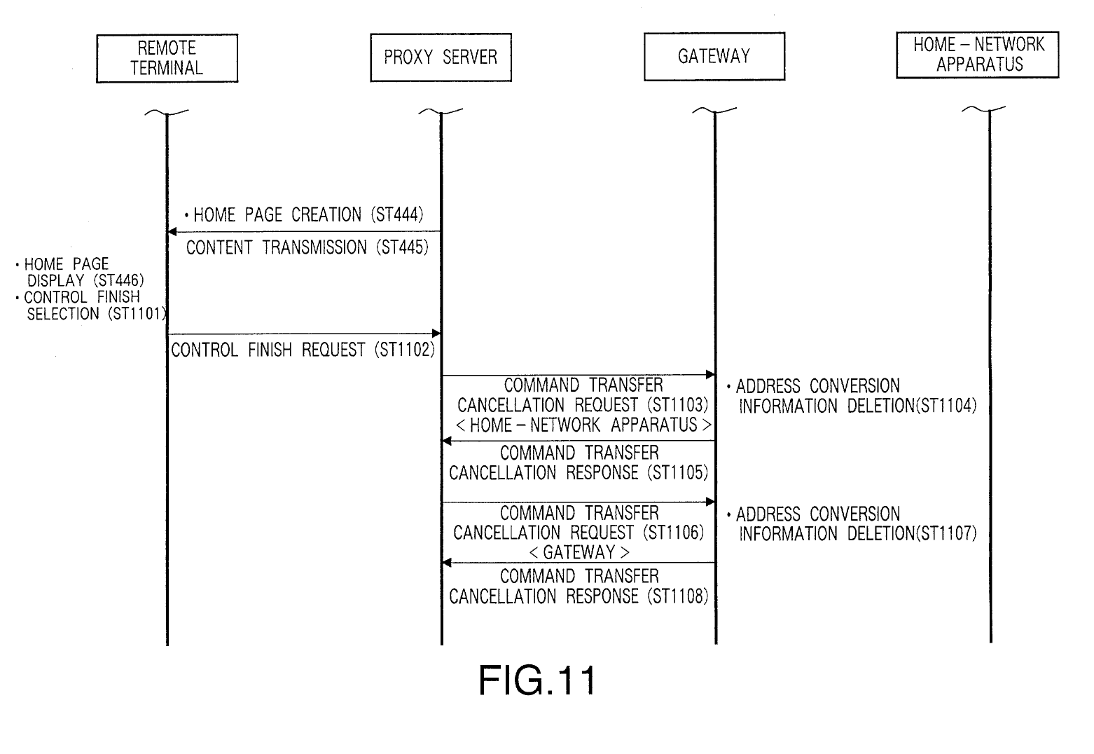

Further, as illustrated in FIG. 10, the content of the home page for notification screen is provided with, in addition to message 100 indicative of control completion, control items 101 to 105 for use in newly making a control request, and finish selecting item 106. The operator selects any one from control items 101 to 105 when newly making a control request. In this way, the control request is made according to the same procedures as in ST422 to ST446.

Meanwhile, when selecting finish selecting item 106 (ST1101), since a control finish request message transmission command to proxy server 14 is embedded in finish selecting item 106, the control finish request message is transmitted as illustrated in FIG. 11 (ST1102). Upon receiving the control finish request message, proxy server 14 transmits a command transfer cancellation request message for requesting to cancel the command transfer setting for the home-network apparatus to gateway 10 (ST1103). Upon receiving the command, gateway 10 deletes address conversion information 91 of the home-network apparatus (VTR 1) in table 90, line 1 illustrated in FIG. 90 (ST1104). Getaway 10 sends back a command transfer cancellation response message for replying that the command transfer setting is cancelled (ST1105). Upon receiving this response, proxy server 14 transmits a command transfer cancellation request message for gateway 10 (ST1106). Upon receiving the command, gateway 10 deletes address conversion information 92 of gateway 10 in table 90, line 2 illustrated in FIG. 9 (ST1107), and sends back a command transfer cancellation response message to proxy server 14 (ST1108). In this way, a series of home-network apparatus control is finished.

As described above, in Embodiment 1, gateway 10 detects home-network apparatuses connected to home networks 3, 4 and 5 connected to gateway 10, and collects information of these apparatuses (including URLs of proxy servers responsible for the apparatuses). Gateway 10 assigns home-network apparatus identifiers to detected home-network apparatuses, associates the home-network apparatus identifiers with the apparatus information to generate home-network apparatus management information, and registers the information with home-network apparatus management information storing section 32 to hold. Further, upon receiving a request from a remote terminal, gateway 10 generates a content of a home page for selection screen that is associated with home-network apparatus identifiers of home-network apparatuses managed by gateway 10 and linked with URLs of proxy servers 14 responsible for the apparatuses to transmit to a remote terminal. In other words, gateway 10 holds the home-network apparatus management information, registered therewith, associating the address information of proxy server 14 with the home-network apparatus identifiers, and opens the home-network apparatus management information to the public on the internet 11 as a home page.

Further, in Embodiment 1, proxy server 14 receives at URL a control request message transmitted in the HTTP protocol, and converts the control request message into the control request command of format enabling a home-network apparatus to directly interpret the command. The server 14 constructs the control request command in IP packets to transmit to gateway 10. Then, gateway 10 performs address conversion and protocol conversion on the IP packets of the control request command to transfer to the home-network apparatus.

A remote terminal thus transmits a control request message to URL of proxy server 14 using the HTTP protocol, whereby the remote terminal is capable of making proxy server 14 perform format conversion on the control request command. In this way, since a remote terminal does not need to generate a control request command that can be directly interpreted by a home-network apparatus and only needs to use a Web browser, it is possible to simplify a configuration of a remote terminal and reduce loads on the terminal. Besides theses advantages, since gateway 10 does not need to interpret a control request message in the HTTP protocol to convert into a control command that can be directly interpreted by a home-network apparatus, it is possible to simplify a configuration of gateway 10 and reduce loads on gateway 10.

Since gateway 10 opens URL of proxy server 14 responsible for home-network apparatuses to the public on the internet 11, remote terminals are capable of acquiring URL from the opened contents. Thus, it is only required for each of operations of remote terminals to know URL of gateway 10, even without knowing URL of proxy server 14 responsible for the home-network apparatus targeted for the control.

In Embodiment 1, gateway 10 detects home-network apparatuses, assigns identifiers to the home-network apparatuses, registers the home-network apparatus management information and opens URL of proxy server 14 to the public, but it may be possible that an apparatus other than gateway 10 performs above operations. Since such an apparatus needs to connect to both home networks 3, 4 and 5and the internet 11, it is preferable to provide gateway 10 originally having WAN side interface 37 and LAN side interfaces 38 to 40 with such functions.

Further, since proxy server 14 is capable of authenticating remote terminals and encrypting control request commands and thereby eliminates the need for remote terminals and gateway 10 to perform the authentication and encryption, it is possible to improve safety (preventing unauthorized people from controlling home-network apparatuses) without complicating configurations of remote terminals and gateway 10 and increasing loads on the terminals and gateway 10.

(Embodiment 2)

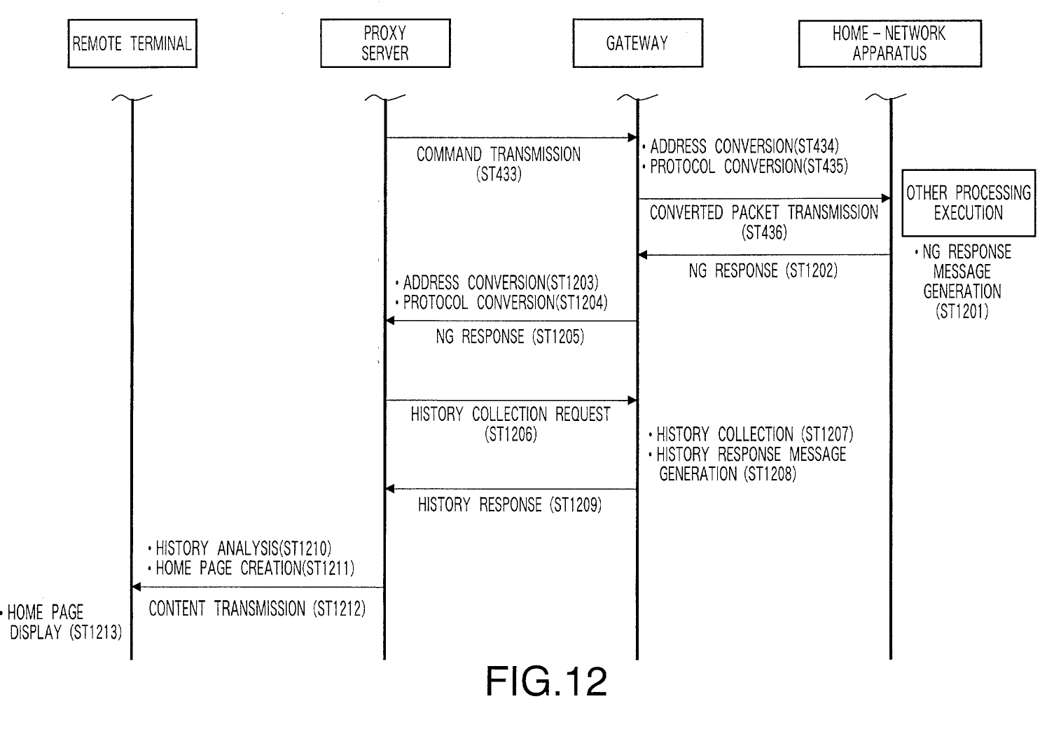

FIG. 12 is a sequence diagram illustrating procedures performed between apparatuses in the network system using the home-network apparatus control method according to Embodiment 2 of the present invention. Procedures in FIG. 12 up to a step that gateway 10 receives IP packets of a control request command and transmits the packets to a home-network apparatus are the same as in ST401 to ST436.

After gateway 10 transmits a converted control request command composed of packets on either home networks 3, 4 or 5 (ST436), when the home-network apparatus is executing other processing that does not permit the home-network apparatus to execute the required control, the control request is rejected. In this case, as described in Embodiment 1, the home-network apparatus generates an NG response message (ST1201) to transmit (ST1202).

Gateway 10 performs address conversion (ST1203) and protocol conversion (ST1204) on the NG response message to transfer to proxy server 14 (ST1205).

Upon receiving the NG response message, proxy server 14 transmits a history collection request message to gateway 10 using the HTTP protocol (ST1206). The history collection request is made using the same procedures as in the control request to a home-network apparatus as described in Embodiment 1. In other words, for the history collection request message, “12326” is used as a transmission source port number. The number is a value set in an item of transmission source address information in address conversion information 92, which is of the case where gateway 10 is targeted for control, in line 2, address conversion information table 90 in FIG. 9. Accordingly, in gateway 10, command transmitting/receiving control section 22 recognizes that the message is a control request (history collection) to gateway 10 by referring to address conversion information 92, and control command executing section 33 in gateway 10 executes the processing (history collection) (ST1207). Specifically, control command executing section 33 refers to control history information storing section 42 to collect the history information. Then, command transmitting/receiving control section 22 generates a history response message from the collected history information (ST1208) to transmit (ST1209).

Upon receiving the history response message, proxy server 14 analyzes the history information contained in the message (ST1210), and generates a content of a home page for history display (ST1211). The home page contains a message indicative of a history, for example, such that “VTR 1 is being used by PC 1 from 16:32, and recording reservation is disabled”. Proxy server 14 transmits a data file of the generated content of the home page to the remote terminal (ST1212). The remote terminal receives the data file to display using the Web server (ST1213). The operator is capable of knowing that the control request fails from the displayed home page.

Herein, as an example of the history information, the case that a control request fails is explained. Further, histories include execution results and execution states of control requests such that the control request is normally accepted and has succeeded, the control is being executed, or the control is completed.

Thus, in Embodiment 2, gateway 10 is provided with command transmitting/receiving control section 22 and control command executing section 33 to enable gateway 10 to recognize a control request to gateway 10 from proxy server 14 and is capable of executing the control. Gateway 10 is further provided with control history information storing section 42, and has the function of collecting the history information by referring to the section 42 to transmit as a message. It is thereby possible that proxy server 14 requests gateway 10 to collect histories, and that a remote terminal acquires a content of a home page including history information to display. As a result, the operator is capable of knowing an execution result or execution state of the control request of the home-network apparatus from the history information on the home page.

In this example, when receiving an NG response message, proxy server 14 requests for history collection (ST1206). However, history collection is not limited to the above case. For example, it may be possible to request for history collection when an OK response message for notifying a success of the control request is received. Further, it may be possible for a remote terminal to request for history collection via proxy server 14 when the response message is received. Furthermore, timing of making a request for history collection is not limited to the time of receiving a response message. For example, it may be possible to perform at regular time intervals, or at the time an operator of a remote terminal instructs.

(Embodiment 13)

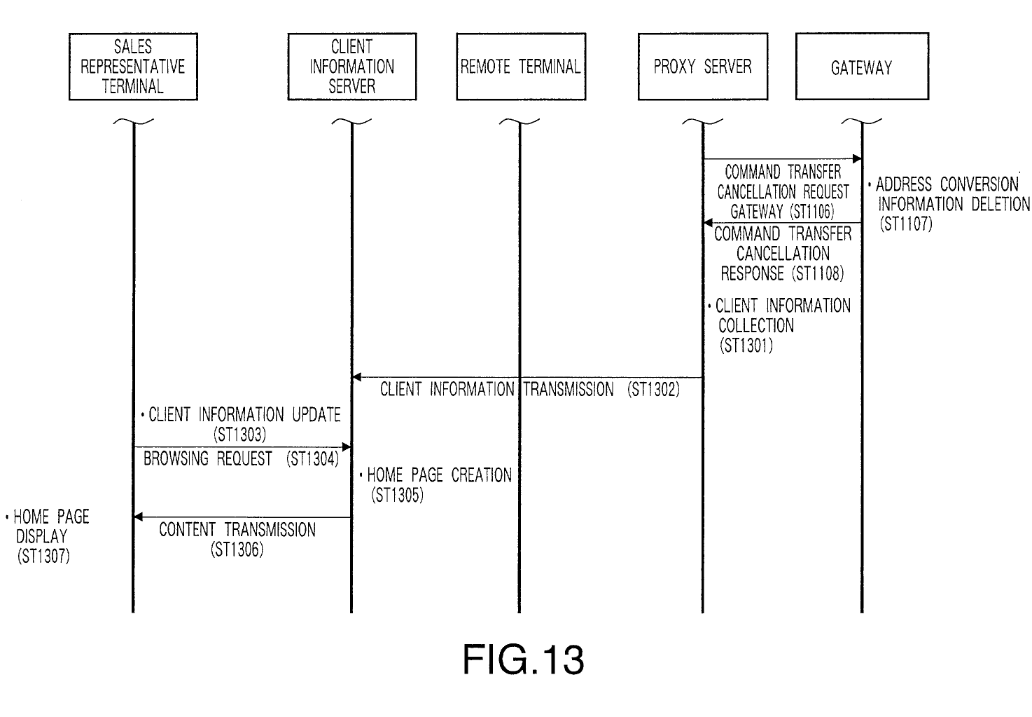

FIG. 13 is a sequence diagram illustrating procedures performed between apparatuses in a network system using a home-network apparatus control method according to Embodiment 3 of the present invention. Procedures illustrated in FI.13 up to ST1108 (ST1101 to ST1108) where the control is finished are the same as in FIG. 11 in Embodiment 1.

In Embodiment 3, as illustrated in FIG. 13, upon receiving a command transfer cancellation response message form gateway 10 (ST1108), proxy server 14 collects client information (ST1301). The client information is one relating to controls for each requester of remote control using a remote terminal, i.e., client. For example, the client information includes a time required for a series of the control, the number of times a command is executed, other states (such as a period of use and continuous running time) of an apparatus obtained during the control, and control history. Proxy server 14 generates the client information, for example, by holding and editing commands transmitted/received to/from gateway 10 and contents of the history information.

Upon completing collection of the client information (ST1301), proxy server 14 transmits the client information to client information server 16 (ST1302). Upon receiving the client information, client information server 16 stores the information for each client, and updates the information when receiving new client information (ST1303).

When a sales representative terminal connected to the internet 11 makes a browsing request (ST1304), client information server 16 generates a content of a client information home page for displaying required client information (ST1305). Then, the server 16 transmits a data file of the generated content of the home page to the sales representative terminal (ST1306). The sales representative terminal displays the content of the home page using the Web browser (ST1307).

In this way, according to Embodiment 3, it is possible for sales representatives to refer to the client information on remote control by clients, it is possible to use the information for sales promotion of home-network apparatuses. More specifically, it is possible to transmit information of new products at the time of the replacement purchase estimated from the period of use, continuous running time, etc. of the home-network apparatus, or promote exchange of a part by e-mail by estimating a wearing extent of the part (for example, a video head).

(Embodiment 4)

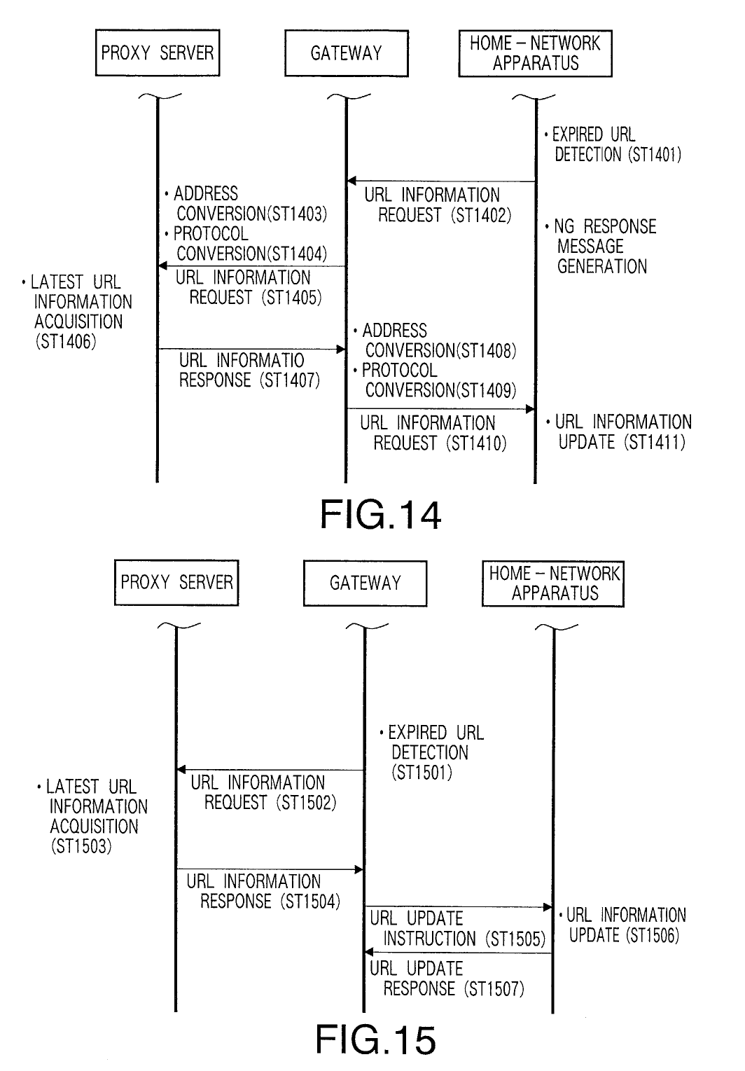

FIG. 14 is a sequence diagram illustrating procedures performed between apparatuses in a network system using a home-network apparatus control method according to Embodiment 4 of the present invention.

Each Home-network apparatus holds, as explained in Embodiment 1, URL of proxy server 14 as one of apparatus information collected by gateway 10. However, there is a case that URL of proxy server 14 is not permanent, and is temporarily assigned with an expiration date. To cope with such a case, in this example, the home-network apparatus manages the expiration date of URL, and when the expiration date expires, acquires latest URL to update.

Specifically, as illustrated in FIG. 14, a home-network apparatus stores an expiration date of URL assigned to proxy server 14, and detects whether or not the expiration date expires. Upon detecting that the expiration date has expired (ST1401), the home-network apparatus transmits a URL information request command for requesting for latest URL to gateway 10 using the communication protocol of a respective one of home networks 3, 4 and 5 (ST1402). Gateway 10 performs address conversion and protocol conversion on the command (ST1403 and ST1404), obtains an URL information request message, and transmits the message to proxy server 14 using the HTTP protocol (ST1405).

Upon receiving the URL information request message, proxy server 14 transmits a URL information response message containing latest URL information set by, for example, a maintenance person to gateway 10, using the HTTP protocol (ST1407). Gateway 10 performs address conversion and protocol conversion on the URL information response message (ST1408 and ST1409) to transfer as a URL information response command on the relevant one of home networks 3, 4 or 5 (ST1410). Upon receiving the URL information response command, the home-network apparatus updates the URL information in the memory using the latest URL information (ST1411).

Another example of update of URL information of proxy server 14 will be described. FIG. 15 is another sequence diagram illustrating procedures performed between apparatuses in the network system using the home-network apparatus control method according to Embodiment 4.

As explained in Embodiment 1, gateway 10 collects URL of proxy server 14 from each home-network apparatus to hold. Then, in this example, gateway 10 manages the expiration date of URL of proxy server 14, and when the expiration date expires, acquires latest URL to update.

Specifically, as illustrate in FIG. 15, gateway 10 stores the expiration date of URL assigned to proxy server 14 in home-network apparatus management information storing section 32, and detects whether or not the expiration date expires. Then, upon detecting expired URL (ST1501), gateway 10 transmits a URL information request message for requesting latest URL of proxy server 14 to proxy server 14 using the HTTP protocol (ST1502). Upon receiving the URL information request message, proxy server 14 acquires latest URL information (ST1503). Then, proxy server 14 transmits a URL information response message containing the acquired latest URL information to gateway 10 using the HTTP protocol (ST1504). Upon receiving the response message, gateway 10 transmits a URL update instructing command containing the latest URL information to the home-network apparatus (ST1505). Upon receiving the message, the home-network apparatus updates the URL information in the memory (ST1506). Then, the home-network apparatus transmits a URL update response command indicative of having updated URL to gateway 10 (ST1507).

In this way, according to Embodiment 4, the home-network apparatus or gateway 10 manages the expiration date of URL of proxy server 14, and when the expiration date expires, acquires latest URL from proxy server 14 to update. It is thereby possible for the home-network apparatus to always hold latest URL of the proxy server, and therefore, it is possible to implement reliable and smooth operations of network systems using the remote control method of the present invention.

Further, in the another example illustrated in FIG. 15, even when a home-network apparatus does not have the function of clock, it is possible for gateway 10 to manage the expiration date of URL of proxy server 14 and update URL, instead of the home-network apparatus.

As is obvious to those skilled in the art, the present invention is capable of being carried into practice using a commercially available digital computer and microprocessor with a program according to techniques as described in above Embodiments. Further, as is obvious to those skilled in the art, the present invention includes computer programs generated by those skilled in the art based on techniques as described in above Embodiments.

Moreover, computer program products are included in the scope of the present invention which are storage media having programs with instructions for a computer to implement the present invention. The storage media include disks such as a floppy(R) disk, optical disk, CD-ROM and magnetic disk, ROM, RAM, EPROM, EEPROM, optomagnetic card, memory card, DVD, etc., but are not limited to the aforementioned media.

As described above, according to the present invention, terminals at remote sites transmit control requests using general protocols without using a specific control program, while eliminating loads for converting the control requests on a gateway, and thereby achieve the remote control.

The present invention is not limited to the above described embodiments, and various variations and modifications may be possible without departing from the scope of the present invention.

This application is based on the Japanese Patent Application No.2001-218604 filed on Jul. 18, 2001, entire content of which is expressly incorporated by reference herein.

What is claimed is:

1. A remote control information opening method in which a remote control terminal remotely controls a controlled apparatus in a network system comprised of the controlled apparatus that is connected to a home network and interprets a home-network control request of home-network control command format to undergo control, the remote control terminal that is connected to an external network and transmits an external-network control request of external-network control command format different from the home-network control command format, a gateway apparatus that connects the home network and the external network, and a proxy server that converts in format, on the external network, the external-network control request into the home-network control request to transmit to the controlled apparatus, said method comprising:
assigning an apparatus identifier for identifying the controlled apparatus to the controlled apparatus;
generating remote control information which associates the apparatus identifier with a proxy server address indicative of an address on the external network of the proxy server responsible for the controlled apparatus; and
opening the remote control information to the public on the external network.

2. The remote control information opening method according to claim 1, wherein an expiration date of the proxy server address is held, and when the expiration date expires, a new proxy server address is acquired to update the remote control information.

3. A remote control information registering method in which a remote control terminal remotely controls a controlled apparatus in a network system comprised of the controlled apparatus that is connected to a home network and interprets a home-network control request of home-network control command format to undergo control, the remote control terminal that is connected to an external network and transmits an external-network control request of external-network control command format different from the home-network control command format, a gateway apparatus that connects the home network and the external network, a proxy server that converts in format, on the external network, the external-network control request into the home-network control request to transmit to the controlled apparatus, and a remote control information opening apparatus that opens remote control information to the public on the external network where the remote control information associates an apparatus identifier for identifying the controlled apparatus with a proxy server address indicative of an address on the external network of the proxy server responsible for the controlled apparatus, said method comprising:
holding the proxy server address of the proxy server responsible for the controlled apparatus; and
registering the proxy server address with the remote control information opening apparatus.

4. The remote control information registering method according to claim 3, wherein an expiration date of the proxy server address is held, and when the expiration date expires, a new proxy server address is acquired.

5. A remote control requesting method in which a remote control terminal remotely controls a controlled apparatus in a network system comprised of the controlled apparatus that is connected to a home network and interprets a home-network control request of home-network control command format to undergo control, a gateway apparatus that connects the home network and an external network, a proxy server that converts in format an external-network control request of external-network control command format available on an external network into the home-network control request to transmit to the controlled apparatus, and a remote control information opening apparatus that opens remote control information to the public on the external network where the remote control information associates an apparatus identifier for identifying the controlled apparatus with a proxy server address indicative of an address on the external network of the proxy server assigned to the controlled apparatus, said method comprising:
acquiring the remote control information from the remote control information opening apparatus;
transmitting the external-network control request to the proxy server address indicated by the acquired remote control information; and
making the proxy server convert in format the external-network control request into the home-network control request and transmit the request to the controlled apparatus.

6. A remote control proxy method in which a remote control terminal remotely controls a controlled apparatus in a network system comprised of the controlled apparatus that is connected to a home network and interprets a home-network control request of home-network control command format to undergo control, the remote control terminal that is connected to an external network and transmits an external-network control request of external-network control command format different from the home-network control command format, a gateway apparatus that connects the home network and the external network, and a proxy information opening apparatus that opens control proxy information to the public on the external network where the control proxy information associates an apparatus identifier for identifying the controlled apparatus with a proxy server address on the external network assigned to the controlled apparatus, said method comprising:
receiving the external-network control request which the remote control terminal transmits to the proxy server address acquired from the proxy information opening apparatus;
converting in format the received external-network control request into the home-network control request; and
transmitting the home-network control request to the controlled apparatus.

7. The remote control proxy method according to claim 6, wherein the home-network control request to transmit to the controlled apparatus is encrypted and transmitted, and either the gateway apparatus or the controlled apparatus is designated as an apparatus for decrypting the encrypted home-network control request.

8. An address converting method in which a remote control terminal remotely controls a controlled apparatus in a network system comprised of the controlled apparatus that is connected to a home network and interprets a home-network control request of home-network control command format to undergo control, the remote control terminal that is connected to an external network and transmits an external-network control request of external-network control command format different from the home-network control command format, a gateway apparatus that connects the home network and the external network, and a proxy server that converts in format, on the external network, the external-network control request into the home-network control request to transmit to the controlled apparatus, said method comprising:
holding address conversion information which associates transmission source information comprised of a transmission source address indicative of an address on the external network of the proxy server and of control specific codes assigned for each control content of the controlled apparatus to which the proxy server requests with post-conversion address information indicative of an address on the home network of the controlled apparatus;
receiving the home-network control request which is transmitted from the proxy server to the address on the external network of the gateway apparatus and which contains the home-network control request containing the transmission source address and the control specific code;
reading the address conversion information which corresponds to the transmission source address and the control specific code; and
converting, according to the address conversion information, a transmission destination address of the home-network control request from an address on the external-network address into an address on the home-network of the controlled apparatus indicated by the post-conversion address information.

9. The address converting method according to claim 8, wherein the gateway apparatus identifies whether or not a received home-network control request is a control request to the gateway apparatus, and when the control request is to the gateway apparatus, executes the requested control over the gateway apparatus without transferring the home-network control request.

10. The address converting method according to claim 9, wherein when a content of the control request to the gateway apparatus is history information collection, the gateway apparatus transmits history information containing at least one of execution results and execution states of control requested to the controlled apparatus.

11. The remote control proxy method according to claim 6, wherein requester information on requesters of remote control is collected, and is registered with a requester information server that provides the information corresponding to an inquiry request from an outer terminal.

12. A remote control information opening apparatus comprising:
an identifier assigning section that assigns an apparatus identifier for identifying a controlled apparatus to the controlled apparatus that is connected to a home network and interprets a home-network control request of home-network control command format to undergo control;
a remote control information generating section that generates remote control information associating the apparatus identifier with a proxy server address indicative of an address on the external network of a proxy server that is responsible for the controlled apparatus and converts in format an external-network control request of external-network control command format different from the home-network control command format transmitted from a remote control terminal into the home-network control request to transmit to the controlled apparatus; and
an opening section that opening the remote control information to the public on the external network.

13. The remote control information opening apparatus according to claim 12, further comprising:
a proxy server address updating section which holds an expiration date of the proxy server address, and when the expiration date expires, acquires a new proxy server address to update the remote control information.

14. A remote control information registering apparatus comprising:
a proxy server address holding section that holds a proxy server address indicative of an address on an external network of a proxy server that converts in format an external-network control request into a home-network control request to transmit to a controlled apparatus, where the external control request has an external-network control command format different from a home-network control command format, and is transmitted from a remote control terminal connected to an external network to a controlled apparatus that is connected to a home network and interprets the home-network control request of the home-network control command format to undergo control; and
a registering section that registers the proxy server address with a remote control information opening apparatus that opens remote control information to the public on the external network, the remote control information associating an apparatus identifier for identifying the controlled apparatus with the proxy server address indicative of the address on the external network of the proxy server responsible for the controlled apparatus.

15. The remote control information registering apparatus according to claim 14, further comprising:
a proxy server address acquiring section which holds an expiration date of the proxy server address, and when the expiration date expires, acquires a new proxy server address.

16. A remote control requesting apparatus comprising:
a remote control information acquiring section that acquires remote control information from a remote control information opening apparatus that opens the remote control information to the public, the remote control information associating an apparatus identifier with a proxy server address, the apparatus identifier for identifying a controlled apparatus that is connected to a home network and interprets a home-network control request of home-network control command format to undergo control, the proxy server address indicative of an address on an external network of a proxy server that converts in format an external-network control request into the home-network control request to transmit to the controlled apparatus, the external control request having an external-network control command format different from the home-network control command format, and being transmitted to the controlled apparatus from a remote control terminal connected to the external network; and
an external-network control request transmitting section which transmits the external-network control request to the proxy server address indicated by the acquired remote control information, and makes the proxy server convert in format the external-network control request into the home-network control request and transmit the request to the controlled apparatus.

17. A remote control proxy server apparatus comprising:
an external-network control request receiving section that receives an external-network control request transmitted to a proxy server address from a remote control terminal that is connected to an external network and acquires the proxy server address from a proxy information opening apparatus that opens control proxy information to the public on the external network, the control proxy information associating an apparatus identifier for identifying a controlled apparatus that is connected to a home network and interprets the home-network control request of home-network control command format to undergo control with the proxy server address indicative of an address on an external network assigned to the controlled apparatus; and
a control request converting section which converts in format a received external-network control request into the home-network control request, and transmits the home-network control request to the controlled apparatus via a gateway apparatus that connects the external network and the home network.

18. The remote control proxy server apparatus according to claim 17, further comprising:
an encryption end terminal designating section which encrypts the home-network control request to transmit to the controlled apparatus, and designates either the gateway apparatus or the controlled apparatus as an apparatus for decrypting the encrypted home-network control request.

19. An address converting apparatus which converts a transmission destination address of a home-network control request from an address on an external network into an address on a home network in a network system comprised of a controlled apparatus that is connected to the home network and interprets the home-network control request of home-network control command format to undergo control, a remote control terminal that is connected to the external network and transmits an external-network control request of external-network control command format different from the home-network control command format, a gateway apparatus that connects the home network and the external network, and a proxy server that converts in format, on the external network, the external-network control request into the home-network control request to transmit to the controlled apparatus, said apparatus comprising:
an address conversion information holding section that holds address conversion information associating transmission source information comprised of a sender address indicative of an address on the external network of the proxy server and control specific codes assigned for each control content of the controlled apparatus to which the proxy server requests with post-conversion address information indicative of an address on the home network of the controlled apparatus;
a home-network control request receiving section that receives the home-network control request which is transmitted from the proxy server to the address on the external network of the gateway apparatus and which contains the home-network control request containing the transmission source address and the control specific code; and
an address converting section which reads the address conversion information that corresponds to the transmission source address and the control specific code, and according to the address conversion information, converts the transmission destination address of the home-network control request into an address on the home-network of the controlled apparatus indicated by the post-conversion address information.

20. The address converting apparatus according to claim 19, further comprising:
a control request identifying section that identifies whether or not a received home-network control request is a control request to the gateway apparatus; and
a control executing section which when the control request is to the gateway apparatus, executes the requested control over the gateway apparatus without transferring the home-network control request.

21. The address converting apparatus according to claim 19, wherein when a content of the control request to the gateway apparatus is history information collection, the control executing section transmits history information containing at least one of execution results and execution states of control requested for the controlled apparatus.

22. The remote control proxy server according to claim 17, further comprising:
a requester information collecting section that collects requester information on requesters of the remote control; and
a requester information registering section that registers the requester information with a requester information server that provides the information corresponding to an inquiry request from an outer terminal.

23. A remote control information opening program that makes a computer function as:
an identifier assigning section that assigns an apparatus identifier for identifying a controlled apparatus to the controlled apparatus that is connected to a home network and interprets a home-network control request of home-network control command format to undergo control;
a remote control information generating section that generates remote control information associating the apparatus identifier with a proxy server address indicative of an address on the external network of a proxy server that is responsible for the controlled apparatus and converts in format an external-network control request of external-network control command format different from the home-network control command format transmitted from a remote control terminal into the home-network control request to transmit to the controlled apparatus; and
an opening section that puts the remote control information on the external network.

24. The remote control information opening program according to claim 23, wherein the computer is further made function as a proxy server address updating section which holds an expiration date of the proxy server address, and when the expiration date expires, acquires a new proxy server address to update the remote control information.

25. A remote control information registering program that makes a computer function as:
a proxy server address holding section that holds a proxy server address indicative of an address on an external network of a proxy server that converts in format an external-network control request into a home-network control request to transmit to a controlled apparatus, where the external control request has an external-network control command format different from a home-network control command format, and is transmitted from a remote control terminal connected to an external network to a controlled apparatus that is connected to a home network and interprets the home-network control request of the home-network control command format to undergo control; and
a registering section that registers the proxy server address with a remote control information opening apparatus that opens remote control information to the public on the external network, the remote control information associating an apparatus identifier for identifying the controlled apparatus with the proxy server address indicative of the address on the external network of the proxy server responsible for the controlled apparatus.

26. The remote control information registering program according to claim 23, wherein the computer is further made function as a proxy server address acquiring section which holds an expiration date of the proxy server address, and when the expiration date expires, acquires a new proxy server address.

27. A remote control requesting program that makes a computer function as:
a remote control information acquiring section that acquires remote control information from a remote control information opening apparatus that opens the remote control information to the public, the remote control information associating an apparatus identifier with a proxy server address, the apparatus identifier for identifying a controlled apparatus that is connected to a home network and interprets the home-network control request of home-network control command format to undergo control, the proxy server address indicative of an address on an external network of a proxy server that converts in format an external-network control request into a home-network control request to transmit to the controlled apparatus, the external control request has an external-network control command format different from a home-network control command format, and being transmitted to the controlled apparatus from a remote control terminal connected to the external network; and
an external-network control request transmitting section which transmits the external-network control request to the proxy server address indicated by the acquired remote control information, and makes the proxy server convert in format the external-network control request into the home-network control request and transmit the request to the controlled apparatus.

28. A remote control proxy server program that makes a computer function as:
an external-network control request receiving section that receives an external-network control request transmitted to a proxy server address from a remote control terminal that is connected to the external network and acquires the proxy server address from a proxy information opening apparatus that opens control proxy information to the public on the external network, the control proxy information associating an apparatus identifier for identifying a controlled apparatus that is connected to a home network and interprets the home-network control request of home-network control command format to undergo control with a proxy server address indicative of an address on an external network assigned to the controlled apparatus; and
a control request converting section which converts in format a received external-network control request into the home-network control request, and transmits the home-network control request to the controlled apparatus via a gateway apparatus that connects the external network and the home network.

29. The remote control proxy server program according to claim 28, wherein the computer is further made function as an encryption end terminal designating section which encrypts the home-network control request to transmit to the controlled apparatus, and designates either the gateway apparatus or the controlled apparatus as an apparatus for decrypting the encrypted home-network control request.

30. An address converting program that makes a computer convert a transmission destination address of a home-network control request from an address on an external network into an address on a home network in a network system comprised of a controlled apparatus that is connected to the home network and interprets the home-network control request of home-network control command format to undergo control, a remote control terminal that is connected to the external network and transmits an external-network control request of external-network control command format different from the home-network control command format, a gateway apparatus that connects the home network and the external network, and a proxy server that converts in format, on the external network, the external-network control request into the home-network control request to transmit to the controlled apparatus, said program making the computer function as an address conversion information holding section that holds address conversion information associating transmission source information comprised of a sender address indicative of an address on the external network of the proxy server and control specific codes assigned for each control content of the controlled apparatus to which the proxy server requests with post-conversion address information indicative of an address on the home network of the controlled apparatus;
a home-network control request receiving section that receives the home-network control request which is transmitted from the proxy server to the address on the external network of the gateway apparatus and which contains the home-network control request containing the transmission source address and the control specific code; and
an address converting section which reads the address conversion information that corresponds to the transmission source address and the control specific code, and according to the address conversion information, converts the transmission destination address of the home-network control request into an address on the home-network of the controlled apparatus indicated by the post-conversion address information.

31. The address converting program according to claim 30, wherein the computer is further made function as a control request identifying section that identifies whether or not a received home-network control request is a control request to the gateway apparatus, and a control executing section which when the control request is to the gateway apparatus, executes the requested control over the gateway apparatus without transferring the home-network control request.

32. The address converting program according to claim 30, wherein when a content of the control request to the gateway apparatus is history information collection, the control executing section transmits history information containing at least one of execution results and execution states of control requested for the controlled apparatus.

33. The remote control proxy server program according to claim 28, wherein the computer is further made function as a requester information collecting section that collects requester information on requesters of the remote control, and a requester information registering section that registers the requester information with a requester information server that provides the information corresponding to an inquiry request from an outer terminal.
